(19) United States
(12) Patent Application Publication
(10) Pub. No.: US 2016/0286839 A1
(43) Pub. Date: Oct. 6, 2016

(54) Non-Reconstituted Stevia Juice Product and Method for Producing the Product

(71) Applicant: MICROWARE LIMITED, Gibraltar (GI)

(72) Inventor: Bentsion KABAKOV, QUEENSWAY QUAY (GI)

(21) Appl. No.: 14/676,841

(22) Filed: Apr. 2, 2015

(51) Int. Cl. A23L 1/222

(52) U.S. Cl. CPC A23L 1/222; A23V 2002/00

(57) ABSTRACT

A non-reconstituted stevia juice food product is produced by crushing a quantity of fresh Stevia leaves to extract Stevia juice. The juice is subjected to a flocculation process, including addition of a flocculant to cause aggregation of suspended solids into flocs followed by separation. The Stevia juice is then passed through at least one adsorptive filtering medium, such as various ion-exchange resins. These processes are preferably performed without dilution, concentration or drying, thereby maintaining medicinal and health benefits of the Stevia plant.

### FIELD AND BACKGROUND OF THE INVENTION

The present invention relates to food products and, in particular, it concerns a non-reconstituted Stevia juice product and method for producing the product.

The plant Stevia rebaudiana, referred to herein simply as “Stevia”, contains significant concentrations of steviol glycosides, predominantly, stevioside and rebaudioside A, which are responsible for a sweet taste of the leaves. The plant is also popularly attributed various medicinal and health benefits, including being helpful in the moderating of blood pressure, helping to balance blood-sugar levels, and anti-bacterial effects possibly contributing to oral hygiene.

Due to the sweetness of the steviol glycosides and the fact that they do not induce a glycemic response, steviol glycosides form the basis for various low-calorie sweetener products. In many cases, particularly where the processing is performed in a different country from cultivation of the Stevia, the leaves are initially dried prior to transportation, and the desired compounds are later extracted from the dried leaves using solvents. The drying process, which is typically done in the field, results in gradual concentration of the compounds in solution together with heating by the sun, and causes various chemical changes to the glycosides. Despite the raw material being naturally occurring, the processing used to isolate individual steviol glycosides often leaves traces of various inedible solvents. The isolated sweetener molecules also clearly lack the medicinal and health benefits of the original plant. Conventional Stevia-based sweetener products are produced in solid powder form, although in some cases the powders are dissolved to provide a liquid sweetener for retail.

### SUMMARY OF THE INVENTION

The present invention is a non-reconstituted Stevia juice food product and a method for producing the product.

According to the teachings of an embodiment of the present invention there is provided, a method comprising: (a) employing a crushing process to a quantity of fresh Stevia leaves to extract Stevia juice; (b) performing a flocculation process including addition of a flocculant to the Stevia juice to cause aggregation of suspended solids into flocs; (c) separating the Stevia juice from the flocs; and (d) passing the Stevia juice through at least one adsorptive filtering medium.

According to a further feature of an embodiment of the present invention, the crushing process, the flocculation process, the separating and the adsorptive passing are performed without dilution, concentration or drying.

According to a further feature of an embodiment of the present invention, the crushing process is performed with an initial quantity of fresh Stevia leaves, and wherein the final quantity of Stevia juice product is between 25 and 65 percent of the initial quantity by mass.

According to a further feature of an embodiment of the present invention, the crushing process is a cold pressing process.

According to a further feature of an embodiment of the present invention, the crushing process is performed with a device selected from the group consisting of: a masticating juicer; and a triturating juicer.

According to a further feature of an embodiment of the present invention, prior to the flocculation process, an initial separation process is performed to remove suspended solids from the Stevia juice.

According to a further feature of an embodiment of the present invention, the initial separation process is performed by vacuum filtration or by use of a centrifugal decanter.

According to a further feature of an embodiment of the present invention, the flocculant is a food additive.

According to a further feature of an embodiment of the present invention, the flocculant is calcium hydroxide.

According to a further feature of an embodiment of the present invention, an edible acid is added to the Stevia juice to balance acidity of the Stevia juice.

According to a further feature of an embodiment of the present invention, the separating the Stevia juice from the flocs is performed by vacuum filtration or by use of a centrifugal decanter.

According to a further feature of an embodiment of the present invention, the at least one adsorptive filtering medium includes at least one ion-exchange resin.

According to a further feature of an embodiment of the present invention, the at least one ion-exchange resin includes a strong-acid cation ion-exchange resin.

According to a further feature of an embodiment of the present invention, the at least one ion-exchange resin includes a weak-base anion ion-exchange resin.

According to a further feature of an embodiment of the present invention, the at least one ion-exchange resin includes a strong-base anion ion-exchange resin.

There is also provided according to the teachings of an embodiment the present invention, a Stevia juice product produced by the above technique.

There is also provided according to the teachings of an embodiment of the present invention, a Stevia juice product comprising juice derived directly from pressing of fresh leaves of Stevia (Stevia rebaudiana), the juice including a mixture of steviol glycosides that makes up between about 40 percent and about 80 percent of the total dissolved solids in the juice by weight.

According to a further feature of an embodiment of the present invention, the liquid basis of the juice is liquid directly derived from the fresh leaves, without dilution or reconstitution.

According to a further feature of an embodiment of the present invention, the mixture of steviol glycosides corresponds to naturally occurring proportions of the steviol glycosides in the fresh leaves of Stevia.

### BRIEF DESCRIPTION OF THE DRAWINGS

The invention is herein described, by way of example only, with reference to the accompanying drawings, wherein:

FIG. 1 is a flow diagram of an exemplary implementation of a method according to the present invention for producing a non-reconstituted Stevia juice food product.

### DESCRIPTION OF THE PREFERRED EMBODIMENTS

The present invention is a non-reconstituted Stevia juice food product and a method for producing the product.

The principles and operation of methods according to the present invention, and the corresponding product, may be better understood with reference to the drawings and the accompanying description.

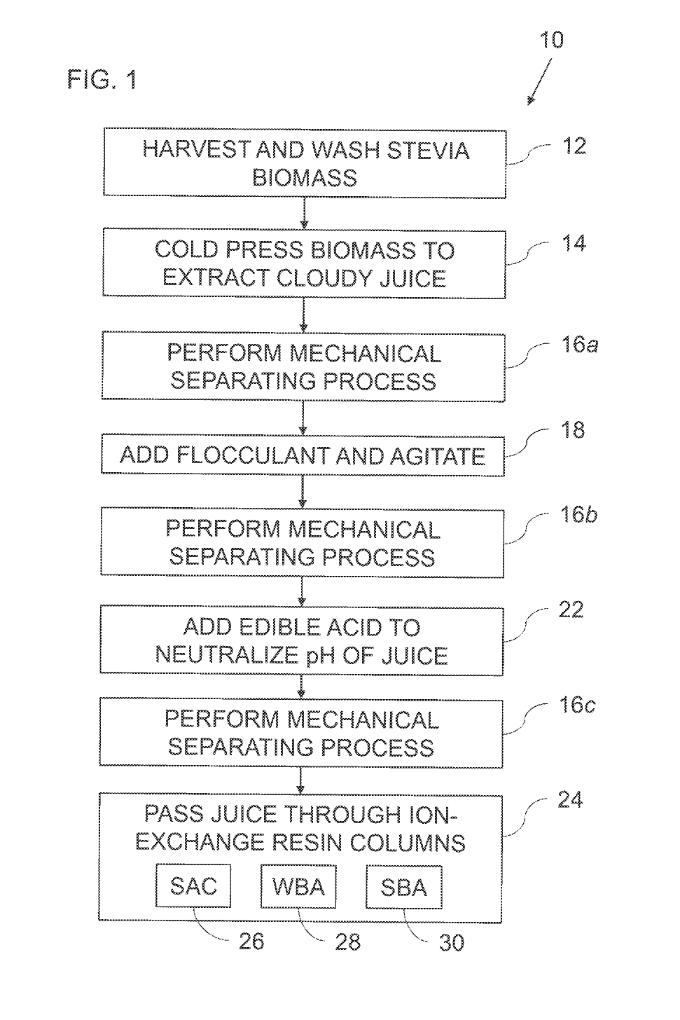

Referring now to the drawings, FIG. 1 is a flow diagram illustrating the steps of an exemplary implementation of a method, generally designated 10, according to the present invention, for producing a non-reconstituted Stevia juice food product.

In general terms, after harvesting the Stevia or otherwise providing fresh Stevia leaves (step 12), the fresh Stevia leaves are crushed to obtain Stevia juice (step 14). This juice is then preferably put through a mechanical separating process (step 16a) to remove a majority of the larger-particle-size suspended solids.

The juice is then processed by performing a flocculation process (step 18) including addition of a flocculant to the Stevia juice to cause aggregation of suspended solids into flocs. These flocs are then removed through a separation process (step 16b). Where necessary, the pH of the juice is adjusted, such as by addition of an edible acid (step 22), preferably returning the juice to its original pH, resulting in further defecation of suspended solids, which are removed in an additional separation process (step 16c). Processing of the Stevia juice is typically completed by passing it through at least one adsorptive filtering medium (step 24) to obtain a Stevia juice product ready for consumption.

It will be noted that the processing is preferably performed without dilution, concentration, crystallization or drying of the Stevia juice. “Dilution” in this context is used to refer to addition of water or another solvent in a ratio of at least 1:1 to the Stevia material at the relevant stage of the processing. “Concentration” is used to refer to volume reduction of a solution by evaporation in order to reduce the volume by at least 50%. “Drying” is used to refer to processing to remove sufficient liquid to derive a solid product. Furthermore, the processing is preferably all performed without significant direct or incidental heating of the juice, with processing temperatures remaining below 50 degrees, and preferably in the range of 10 degrees to 35 degree Celsius, with a preference for slight cooling where appropriate to maintain temperatures in the 10-20 degree range. As a result of avoiding dilution, concentrating and heating processes, the juice remains essentially a “fresh” juice, not requiring reconstitution from powder or concentrate. The juice is processed only to remove various heavy organic components and other components released by the cold-pressing process which would otherwise render the juice less palatable, but while maintaining most if not all of the medical and health benefits attributable to the fresh Stevia plant.

Turning now to the various steps of the process illustrated in FIG. 1 in more detail, step 12 may optionally include other simple pre-processing operations where required. These may include washing or otherwise cleaning off any mud or other foreign matter, and removing leaves from woody stalks. The Stevia plant material (also referred to here as “biomass”) may also be cut and/or bundled into pieces or bunches of suitable dimensions for feeding into the juicer device to be used.

The crushing process of step 14 is preferably performed using a cold-press device of a type suitable for extracting juice from leaves. Suitable types of juicer include single auger devices variously referred to as an “extrusion juicer” or a “masticating juicer”, and double-auger or “double gear” juicers, also referred to as a “triturating juicer”. A subclass of suitable devices are commercially available, sold as “wheatgrass extruder juicers”. AU of the aforementioned devices are well known per se, and are readily commercially available, and so will not be described here in detail. The cold-press juicing process preferably results in a quantity of cloudy Stevia juice which is between about 60 and 85 percent by weight of the initial mass of fresh Stevia leaves. Due to the very high solubility of the glycosides (up to 0.8 grains per milliliter), the resulting juice typically contains a large majority of the total glycosides in the original Stevia biomass, typically approaching as much as 96% thereof.

An initial separation process 16a is preferably performed prior to flocculation in order to remove suspended solids from the Stevia juice. The separation may be performed by a mechanical filtering process, most preferably using vacuum filtration or an agitated Nutsche filter, preferably with a sub-micron filter medium. Alternatively, a centrifugal decanter may be used to remove a large proportion of the suspended solid particles. The initial separation process preferably reduces the remaining quantity of suspended solids to no more than about 2 grams per liter of juice.

A preferred but non-limiting example of a flocculant for flocculation process 18 is calcium hydroxide Ca(OH)₂, which is preferably added in sufficient quantity to bring the pH of the Stevia juice up to about 12. Agitation of the juice is effective to enhance flocculation, leading to formation of flocs, which are then removed by a subsequent separation step 16k which again is typically either vacuum filtration or centrifugal decanting.

In the case of an alkalis flocculant, such as calcium hydroxide, the pH is preferably chemically rebalanced, most preferably by a further defecation (flocculation) agent. Suitable agents include aluminum or ferric chloride, but more preferably, an edible acid is used, most preferably, phosphoric acid, again with agitation/stirring. A range of pH considered suitable for the final juice is in the range of 5-8, and most preferably between 5.5 and 6.5, corresponding to the original pH of the freshly pressed juice. The addition of the further defecation agent results in formation of further flocs, which are removed by an additional separation step 16c, which is typically performed in a similar manner to steps 16a and/or 16b.

The preferred flocculation/defecation agents are chosen to be acceptable food additives. Although the added compounds are preferably removed by subsequent processing, such as by the ion exchange resin processing described below, any residual presence of these compounds would not raise any concerns in regard to safety, and would not require regulatory limitations on consumption, as sometimes occurs with otherwise “natural” sweeteners due to inedible residual compounds remaining from their chemical processing.

It should be noted that quite similar results may be achieved with a reduced number of separation steps, for example omitting steps 16a and 16b, and performing only a single separation step subsequent to addition of both the calcium hydroxide and the phosphoric acid. Furthermore, the separation may optionally be integrated with the subsequent processing by passing through an adsorptive filtering medium. For example, the mechanical separation may be performed using a flow column filled with alumina as a filtering medium. However, the repeated separation at, different stages as described hereinabove is believed to result in an optimum quality of the final product.

Further processing of the Stevia juice to render the product ready for consumption preferably includes passing the juice through at least one adsorptive filtering medium. The adsorptive filtering medium may be implemented using various materials, including but not limited to, active charcoal and ion-exchange resins. Ion-exchange resins, formed from suitably impregnated macro-porous resin beads, are particularly preferred due to their convenience. A typical combination useful for processing the Stevia juice according to the present invention includes one or more separation column containing a SAC (strong-acid cation) ion-exchange resin 26, a WBA (weak-base anion) ion-exchange resin 28, and/or a SBA (strong-base anion) ion-exchange resin 30. The adsorptive filtering mediums are preferably chosen to be effective to remove the calcium and phosphate ions introduced by the flocculants, and other salts and aromatic oils not wanted in the final product. The SBA ion-exchange resin has been found particularly effective for removing any residual plant-smell from the juice.

Although no further processing beyond the adsorptive filtering is typically required, shelf life of the product may optionally be extended by additional of one or more preservative compound. Preservation by heat treatment is less desirable since it may compromise some of the medicinal and health benefits of the juice and may cause chemical modification of some of the glycosides, but this option also falls within the scope of the invention.

Overall, the yield of the final Stevia juice product is typically between 25 and 60 percent of the initial quantity of fresh Stevia leaves by mass, and preferably at least 35 percent. For hydroponically cultivated Stevia, the relatively “juicy” plants have been found to yield 50-60% weight as juice.

The total mixed stevia glycoside content of the final juice produced according to the present invention is typically between 40% and 80% by weight of the total dissolved content of the juice, and typically in the range of 50%-60%.

### Example

Hydraulically cultivated Stevia (Stevia rebaudiana) juicy plants were harvested, and 5 kg of fresh leaves were fed into a masticating juicer. This resulted in approximately 4 liters of green juice having a pH of about 6. The juice was passed through a vacuum filter, resulting in 3.2 liters of dark green juice.

The juice was transferred to the flask of an agitator and 8 grams per liter of calcium hydroxide were added to produce a pH of 12. The juice was left with the agitator running for 30 minutes, after which clumps of gelatinous-looking yellow material were observed. The juice was again put through the vacuum filter, resulting in a slightly yellow cake and approximately 2.7 liters of clear, green-brown filtrate.

A quantity of 11 grams per liter of 65% phosphoric acid was added to the filtrate until the pH reached 6. The juice was again put through the vacuum filter, resulting in a gray-beige cake and approximately 2.5 liters of clear dark-brown filtrate.

The juice was then passed through a sequence of three ion-exchange resin filtration columns containing SAC, WBA and SBA resins, respectively. In order to recover all of the juice from the columns, the columns were flushed with a small quantity of water at the end of the batch, resulting in a final quantity of 3 liters of the final juice product.

The resulting Stevia juice product was a slightly yellow liquid, more viscous than water but readily pourable. The liquid had a strong sweet taste, and formed a pleasant, sweet drink with a delicate fruitiness when mixed in a ratio of about 1:12 with hot or cold water. A quantity of 1-2 tsp. was found to be effective to impart noticeable sweetness to a cup of tea or coffee, similar to 1-2 tsp of sugar.

Under chemical analysis, the Stevia juice product was found to contain a mixture of steviol glycosides in proportions similar to the naturally occurring proportions in Stevia leaves. The total steviol glycoside content made up about 50% of the total dissolved solids in the juice, corresponding to between 3.6 and 4 grams per liter of glycosides. Given an estimated total glycoside content in the initial hydroponically cultivated juicy Stevia leaves of between 2.2 and 2.4 grams per kilogram, the yield of glycosides in the juice was estimated at about 96% of the total expected content of steviol glycosides in the leaves.

The Stevia juice was found to be free from ash (mineral salts). The juice contained roughly 50% non-glycoside content from the fresh plants, but was found to have a pleasant flavor without any “plant-like” flavor or bitterness. These additional components of the natural Stevia juice are believed to preserve much of the medical and health benefits attributed to the natural plant.

For the purpose of comparison, a solution was made up using corresponding quantities of stevia glucosides (white powders) derived by conventional commercial techniques so as to make up a solution of 3.6 grams per liter of stevia glucosides in proportions similar to the naturally occurring proportions. The Stevia juice derived by the present invention and the reconstituted glucoside solution were both analyzed in a UV absorbance spectrometer.

After calibrating the device with pure water, the reconstituted glucoside solution exhibited a peak absorption in the 200-210 nm range which was measured as about 300 absorption units (a.u.) (relative units), while the natural Stevia juice measured an absorption in the same range measuring only about 200 a.u. After the Stevia juice underwent heat treatment in a sealed vessel (without concentration by loss of water), the same absorption peak was measured at about 300 a.u.

These observations are believed to be indicative that the stevia glucosides in the natural Stevia juice derived according to the teachings of the present invention are to a large extent maintained in the same chemical form as they occur in the plant, whereas the glycosides derived by conventional techniques, or which have undergone heat treatment, become chemically modified.

It will be appreciated that the above descriptions are intended only to serve as examples, and that many other embodiments are possible within the scope of the present invention as defined in the appended claims.

What is claimed is:

1. A method comprising:
(a) employing a crushing process to a quantity of fresh Stevia leaves to extract Stevia juice;
(b) performing a flocculation process including addition of a flocculant to the Stevia juice to cause aggregation of suspended solids into flocs;
(c) separating the Stevia juice from the flocs; and
(d) passing the Stevia juice through at least one adsorptive filtering medium.

2. The method of claim 1, wherein said crushing process, said flocculation process, said separating and said adsorptive passing are performed without dilution, concentration or drying.

3. The method of claim 2, wherein said crushing process is performed with an initial quantity of fresh Stevia leaves, and wherein the final quantity of Stevia juice product is between 25 and 65 percent of said initial quantity by mass.

4. The method of claim 1, wherein said crushing process is a cold pressing process.

5. The method of claim 1, wherein said crushing process is performed with a device selected from the group consisting of: a masticating juicer; and a triturating juicer.

6. The method of claim 1, further comprising, prior to said flocculation process, performing an initial separation process to remove suspended solids from the Stevia juice.

7. The method of claim 6, wherein said initial separation process is performed by vacuum filtration or by use of a centrifugal decanter.

8. The method of claim 1, wherein said flocculant is a food additive.

9. The method of claim 8, wherein said flocculant is calcium hydroxide.

10. The method of claim 8, further comprising adding an edible acid to the Stevia juice to balance acidity of the Stevia juice.

11. The method of claim 1, wherein said separating the Stevia juice from the floes is performed by vacuum filtration or by use of a centrifugal decanter.

12. The method of claim 1, wherein said at least one adsorptive filtering medium includes at least one ion-exchange resin.

13. The method of claim 12, wherein said at least one ion-exchange resin includes a strong-acid cation ion-exchange resin.

14. The method of claim 12, wherein said at least one ion-exchange resin includes a weak-base anion ion-exchange resin.

15. The method of claim 12, wherein said at least one ion-exchange resin includes a strong-base anion ion-exchange resin.

16. A Stevia juice product produced by the method of claim 1.

17. A Stevia juice product comprising juice derived directly from pressing of fresh leaves of Stevia (Stevia rebaudiana), said juice including a mixture of steviol glycosides that makes up between about 40 percent and about 80 percent of the total dissolved solids in the juice by weight.

18. The Stevia juice product of claim 17, wherein the liquid basis of the juice is liquid directly derived from the fresh leaves, without dilution or reconstitution.

19. The Stevia juice product of claim 17, wherein the mixture of steviol glycosides corresponds to naturally occurring proportions of the steviol glycosides in the fresh leaves of Stevia.
